(19) United States
(12) Patent Application Publication
(10) Pub. No.: US 2008/0024518 A1
(43) Pub. Date: Jan. 31, 2008

(54) Pixel Shift Display With Minimal Noise

(76) Inventors: Brent William Hoffman, Mooresville, IN (US); Thomas Dale Yost, Indianapolis, IN (US); Donald Hanry Willis, Indianapolis, IN (US)

Correspondence Address: THOMSON LICENSING LLC, Two Independence Way, Suite 200, PRINCETON, NJ, 08540, US

(21) Appl. No.: 11/579,222

(22) PCT Filed: May 4, 2005
(86) PCT No.: PCT/US05/15386

§ 371 Date: Oct. 30, 2006

Related U.S. Application Data
(60) Provisional application No. 60/568,496, filed on May 6, 2004.

(51) Int. Cl. G09G 5/00

(52) U.S. Cl. 345/611

(57) ABSTRACT

Within a display system that has pixel arrays displayed during first and second intervals, visible noise reduction occurs by confining the noise to one interval by combining the fractional part of each first interval pixel with the fractional part of at least one second interval pixel. If the combined fractional parts has a value of at least unity, the integer part of the at least one second interval pixel increases by unity while its fractional part becomes zero. The combination of the fractional parts less unity replaces the fractional part of the first interval pixel. While the combined value of fractional parts remains below unity, the combined value replaces the fractional part of the second interval pixel and the fractional part of the first interval pixel becomes zero. In this way, light intensity shifting occurs between intervals so that no noticeable brightness variation occurs across the overall scene.

### CROSS-REFERENCE TO RELATED APPLICATIONS

This application claims priority under 35 U.S.C. 119(e) to U.S. Provisional Patent Application Ser. No. 60/568,496, filed on May 6, 2004, the teachings of which are incorporated herein.

### TECHNICAL FIELD

This invention relates to a technique for minimizing noise in a pulse width modulated display.

### BACKGROUND ART

There presently exist television projection systems that utilize a type of semiconductor device known as a Digital Micromirror Device (DMD). A typical DMD comprises a plurality of individually movable micromirrors arranged in a rectangular array. Each micromirror pivots about a limited arc, typically on the order of 10°-12° under the control of a corresponding driver cell that latches a bit therein. Upon the application of a previously latched “1” bit, the driver cell causes its associated micromirror to pivot to a first position. Conversely, the application of a previously latched “0” bit to the driver cell causes the driver cell to pivot its associated micromirror to a second position. By appropriately positioning the DMD between a light source and a projection lens, each individual micromirror of the DMD device, when pivoted by its corresponding driver cell to the first position, will reflect light from the light source through the lens and onto a display screen to illuminate an individual picture element (pixel) in the display. When pivoted to its second position, each micromirror reflects light away from the display screen, causing the corresponding pixel to appear dark. An example of such DMD device is the DMD of the DLP™ system available from Texas Instruments, Dallas Tex.

Television projection systems that incorporate a DMD typically control the brightness of the individual pixels by controlling the interval during which the individual micromirrors remain “on” (i.e., pivoted to their first position), versus the interval during which the micromirrors remain “off” (i.e. pivoted to their second position), hereinafter referred to as the micromirror duty cycle. To that end, such present day DMD-type projection systems typically use pulse width modulation to control the pixel brightness by varying the duty cycle of each micromirror in accordance with the state of the pulses in a sequence of pulse width segments. Each pulse width segment comprises a string of pulses of different time duration. The actuation state of each pulse in a pulse width segment (i.e., whether each pulse is turned on or off) determines whether the micromirror remains on or off, respectively, for the duration of that pulse. In other words, the larger the sum of the total widths of the pulses in a pulse width segment that are turned on (actuated) during a picture interval, the longer the duty cycle of the micromirror associated with such pulses and the higher the pixel brightness during such interval.

In television projection systems utilizing such a DMD imager, the picture period, (i.e., the time between displaying successive images), depends on the selected television standard. The NTSC standard currently in use in the United States employs a picture period (frame interval) of 1/60 second whereas certain European television standards (e.g., PAL) employ a picture period of 1/50 second. Present day DMD-type television projection systems typically provide a color display by projecting red, green, and blue images either simultaneously or in sequence during each picture interval. A typical DMD-type projection system utilizes a color changer, typically in the form of a motor-driven color wheel, interposed in the light path of the DMD. The color wheel has a plurality of separate primary color windows, typically red, green and blue, so that during successive intervals, red, green, and blue light, respectively, falls on the DMD.

Television projection systems that utilize a DMD imager sometimes exhibit an artifact known as “the screen door effect” which manifests itself as a faint grid-like pattern on the screen. To overcome this problem, a newer version of the DMD practices pixel shifting. This type of new DMD imager possesses a quincunx array of “diamond pixel” mirrors. These diamond pixel mirrors actually comprise square pixel mirrors oriented at a 45° angle. During a first interval, light reflected from the diamond pixel micromirrors strikes a wobble mirror or the like, which in one position, can effect a display of about one-half the pixels. During a second interval, the wobble mirror pivots to effect a display of the remaining half of the pixels. For purposes of discussion, the pixels displayed during the first and second intervals will be referred to as “first interval” and “second interval” pixels, respectively.

In addition to practicing pixel shifting, this new type DMD also performs error diffusion. While the exact process by which this new type of DMD accomplishes error diffusion remains a trade secret, certain aspects of its operation are known. The incoming pixel values for display by the new type of DMD undergo processing through a degamma table resulting in each pixel signal having an integer value and a fractional value. Since a DMD can only display integer values, the fractional part associated with each pixel value represents an error. An error diffuser adds this fractional part to the integer and fractional part of the pixel value associated with a neighboring pixel displayed during the same interval. If the integer value of the sum increases, the adjacent pixel will display the result by increasing in brightness by 1 Least Significant Bit (LSB). The sum of the fractional parts can sometimes yield a fractional value that is passed on to yet another first interval pixel for combination with the integer and fractional part of its associated pixel value. Each pixel appears not to receive the error from more than-one other pixel. Despite efforts to reduce noise, the combination of the new DMD imager with the above-described error diffuser, sometimes will display an inordinate amount of error diffusion noise.

Thus, there exists a need for a technique that reduces such error diffusion noise.

### BRIEF SUMMARY OF THE INVENTION

Briefly, in accordance with a preferred embodiment of the present principles, there is provided a method for reducing noise in pulse width modulated display in which first pixels appear during a first interval and second pixels appear during a second interval. The method commences by filtering a set of incoming pixel values, each indicative of the brightness of a corresponding pixel so that after filtering, each pixel value has an integer and fractional part. Each first interval pixel undergoes a grouping with at least one second interval pixel that is spatially adjacent from the first interval pixel. The fractional part of the first integer pixel value is combined with the fractional part of the at least one grouped second interval pixel value. The brightness of the at least one grouped second interval pixel is controlled in accordance with the fractional combination of pixel values.

If the value of the combined fractional parts of the grouped first and second interval pixel values at least equals unity, then the integer part of the second interval pixel value increases by unity and its fractional part becomes zero. Thus, the at least one second interval pixel increases in brightness. The combined fractional parts less unity, now becomes the fractional part of the first interval pixel. While the combined fractional parts remains below unity, the combined value replaces the fractional part of the second interval pixel, with the fractional part of the first interval pixel becoming zero.

The noise reduction method described above advantageously reduces the incidence of visible noise by confining the noise to one interval. When the combined fractional parts at least equal unity, the second interval pixel has no noise. The noise if any becomes associated with the first interval pixel. When the combined fractional parts do not exceed unity, the noise if any becomes associated with the second interval pixel, with no noise associated with the first interval pixel.

### BRIEF SUMMARY OF THE DRAWINGS

FIG. 1 depicts a block diagram of an exemplary display system useful for practicing the present invention;

FIG. 2 depicts a portion of the color wheel of the system of FIG. 1; and

FIG. 3 depicts a portion of the pixel array within the DMD imager in the display system of FIG. 1 illustrating the pixel shift.

### DETAILED DESCRIPTION

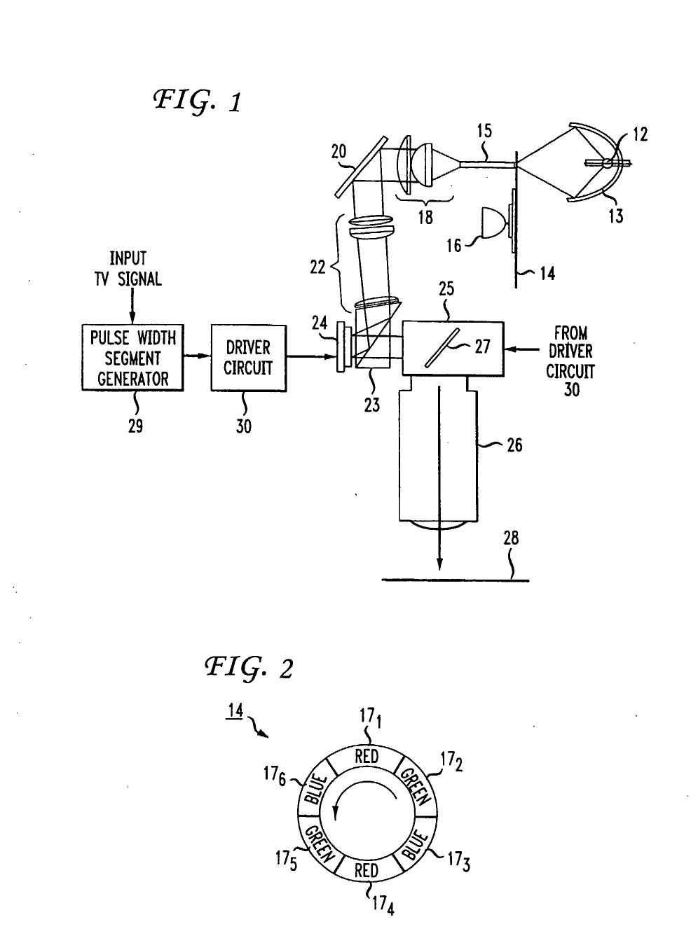

FIG. 1 depicts a present-day color display system 10 of the type disclosed in the Application Report “Single Panel DLP™ Projection System Optics” published by Texas Instruments, June 2001 and incorporated by reference herein. The system 10 comprises a lamp 12 situated at the focus of an elliptical reflector 13 that reflects light from the lamp through a color wheel 14 and into an integrator rod 15. A motor 16 rotates the color wheel 14 to place a separate one of red, green and blue primary color windows between the lamp 12 and the integrator rod 15. In an exemplary embodiment depicted in FIG. 2, the color wheel 14 has diametrically opposed red, green and blue color windows 17₁ and 17₄, 17₂ and 17₅, and 17₃ and 17₆, respectively. Thus, as the motor 16 rotates the color wheel 14 of FIG. 2 in a counter-clockwise direction, red, green and blue light will strike the integrator rod 15 of FIG. 1 in an RGBRGB sequence. In practice, the motor 16 rotates the color wheel 14 at a sufficiently high speed so that during each picture interval, red, green and blue light-each strikes the integrator rod 4 times, yielding 12 color images within the picture interval. Other mechanisms exist for successively imparting each of three primary colors. For example, a color scrolling mechanism (not shown) could perform this task as well.

Referring to FIG. 1, the integrator rod 15 concentrates the light from the lamp 12, as it passes through a successive one of the red, green and blue color windows of the color wheel 14, onto a set of relay optics 18. The relay optics 18 spread the light into a plurality of beams that strike a fold mirror 20, which reflects the beams through a set of lenses 22 and onto a Total Internal Reflectance (TIR) prism 23. The TIR prism 23 reflects the light onto a Digital Micromirror Device (DMD) 24, such as the DMD device manufactured by Texas Instruments, for reflection into a pixel shift mechanism 25 that directs the light into a lens 26 for projection on a screen 28. The pixel shift mechanism 25 includes a wobble mirror 27 controlled by an actuator (not shown) such as a piezoelectric crystal or magnetic coil.

The DMD 24 takes the form of a semiconductor device having a plurality of individual mirrors (not shown) arranged in an array. By way of example, the smooth picture DMD manufactured and sold by Texas Instruments has an array of 460,800 micromirrors, which as described hereinafter can achieve a picture display of 921,600 pixels. Other DMDs can have a different arrangement of micromirrors. As discussed previously, each micomirror in the DMD pivots about a limited arc under the control of a corresponding driver cell (not shown) in response to the state of a binary bit previously latched in the driver cell. Each micromirror rotates to one of a first and a second position depending on whether the latched bit applied to the driver cell, is a “1” or a “0”, respectively. When pivoted to its first position, each micromirror reflects light into the pixel shift mechanism 25 and then into the lens 26 for projection onto the screen 28 to illuminate a corresponding pixel. While each micromirror remains pivoted to its second position, the corresponding pixel appears dark. The interval during which each micromirror reflects light (the micromirror duty cycle) determines the pixel brightness.

The individual driver cells in the DMD 24 receive drive signals from a driver circuit 30 of a type well known in the art and exemplified by the circuitry described in the paper “High Definition Display System Based on Micromirror Device”, R. J. Grove et al.. International Workshop on HDTV (October 1994) (incorporated by reference herein.). The driver circuit 30 generates drive signals for the driver cells in the DMD 24 in accordance with pixel signals supplied to the driver circuit by a processor 29, depicted in FIG. 1 as a “Pulse Width Segment Generator.” Each pixel signal typically takes the form of a pulse width segment comprised a string of pulses of different time duration, the state of each pulse determining whether the micromirror remains on or off for the duration of that pulse. The shortest possible pulse (i.e., a 1-pulse) that can occur within a pulse width segment (some times referred to as a Least Significant Bit or LSB) typically has a 8-microsecond duration, whereas the larger pulses in the segment each have a duration longer than the LSB interval in practice, each pulse within a pulse width segment corresponds to a bit within a digital bit stream whose state determines whether the corresponding pulse is turned on or off. A “1” bit represents a pulse that is actuated (turned on), whereas a “0” bit represents a pulse that is de-actuated (turned off).

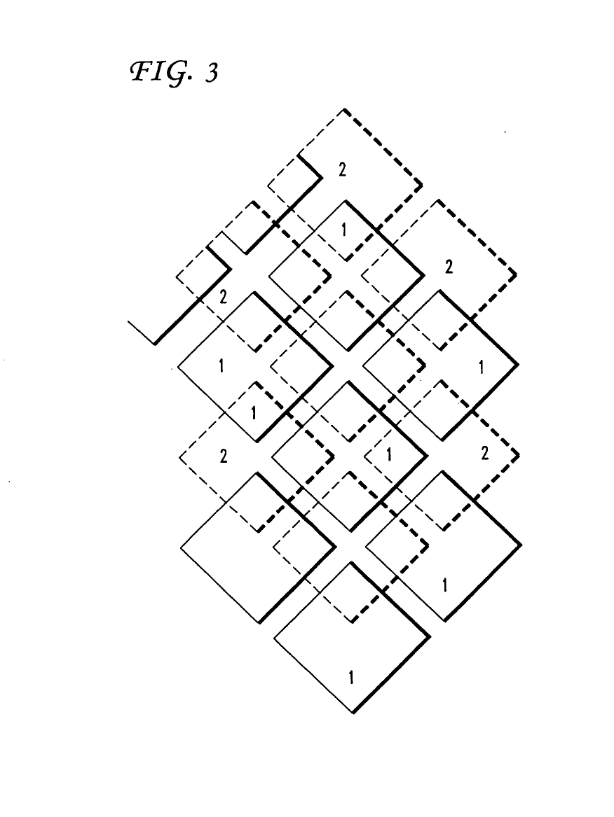

The driver circuit 30 also controls the actuator within the pixel shift mechanism 25. During a first interval, the actuator within the pixel shift mechanism 25 maintains the wobble mirror 27 in a first position to effect a display of about one-half the pixels, each designated by the solid line rectangle bearing reference numeral 1 in FIG. 3. During a second interval, the actuator within the pixel shift mechanism 25 displaces the wobble mirror 27 to a second position to effect a display of the remaining half of the pixels, each designated by the dashed line rectangle bearing reference numeral 2 in FIG. 3. As can be appreciated, the pixel shift mechanism 25 effectively doubles the number of displayed pixels attributable to each micromirror.

In the prior art, the DMD 24 accomplishes error diffusion although the exact process by which this occurs remains a trade secret to the DMD manufacturer. What is known is that incoming pixel values for display by the DMD 24 undergo processing through a degamma table (not shown). The pixel values at the output of the degamma table will have integer and fractional parts. Since the DMD 24 will only display integer values, the fractional part associated with each pixel value represents an error. An error diffuser (not shown) adds this fractional part to the integer and fractional part of the pixel value associated with a neighboring pixel displayed during the same interval. If the integer value of the sum increases, the adjacent pixel will display the higher integer. The sum of the fractional parts can sometimes yield a fractional value that is passed on to yet another first interval pixel for combination with the integer and fractional part of its associated pixel value. Each pixel appears to receive the error from no more than one other pixel. In practice; this type of error diffusion practiced by the DMD 24 yields a visible error.

In accordance with the present principles, a reduction in the visible error occurs by combining the pixel values of each first interval pixel with at least one grouped second interval pixels that lies spatially adjacent to the corresponding first interval pixel. Such grouping can best be seen by reference to FIG. 3, which shows a portion of a smooth pixel array of the DMD 24 of FIG. 1. The elements in FIG. 3 bearing the designation “1” refer to first interval pixels, whereas the elements bearing the designation “2” refer to second interval pixels, one or more of which are grouped with an associated first interval pixel.

To achieve noise reduction in accordance with the present principles, the fractional part of each first interval pixel intensity value undergoes a combination with the fractional part of the at least one grouped second interval pixel intensity value. If the combined fractional parts at least equals unity, then the integer part of the intensity of the at least one second interval pixel value increases by unity and its fractional part becomes zero. The combined fractional parts less the value of unity, now replaces the fractional part of the first interval pixel. In this way, a shift in light intensity occurs between the first and second intervals. The second interval pixel thus increases in light intensity by unity, while the intensity of first interval pixel decreases because the combined fractional parts less unity, is not larger, and is most likely smaller than the previous fractional part of the first interval pixel.

TABLE I graphically illustrates the above-described combination of the first and second interval pixel values. As seen in TABLE 1, the terms “Pixel 1” and “Pixel 2” refer to the first and second interval pixel intensity values, respectively, have integer parts “a” and “c” respectively, and fractional parts “b” and “c”. The integer-and fractional parts of the pixel values for Pixels 1 and 2 appear as “a.b” and “c.d”, respectively.

TABLE I

| | Pixel 1 | Pixel 2 |
|---|---|---|
| Incoming pixel values | a · b | c · d |
| Sum of fractional parts | b + d | |
| New pixel values (b + d < 1) | a | c · (b + d) |
| New pixel values (b + d > 1) | a · (b + d − 1) | c + 1 |

When the combination of fractional parts (b+d) of the first and at least one second interval pixels (Pixel 1 and Pixel 2, respectively) exceed unity, the integer part (c) for Pixel 2 increases by unity. The combined fractional parts of Pixels 1 and 2, less unity (corresponding to the expression b+d−1) now replaces the fractional part of Pixel 1. When the combination of fractional parts (b+d) does not exceed unity, the combination value (b+d) replaces the prior fractional part for Pixel 2, while the fractional part of the first interval pixel (Pixel 1) becomes zero.

Using this technique, the fractional part of the second interval pixel value becomes zero when the combined fractional value b+d≧1. Under such circumstances, all of the error diffusion noise if any appears in the first interval to balance in the increase in the light intensity in the second interval caused by incrementing the integer part of the second interval pixel by unity. When the combined fractional value does not exceed unity (i.e., b+d<1); the noise remains associated with the second interval, with no noise now associated with the first interval pixel. Thus, the overall light within the scene (i.e., within the first and second intervals) remains about the same because the shift in intensity as a result of the noise reduction process of the present principle occurs between intervals.

Although the method described above grouped a single second interval pixel with a first interval pixel, other groupings could occur. For example, a grouping could occur between each first interval pixel and as many as four spatially adjacent second interval pixels. The combination of pixel values and intensity adjustment described with respect to TABLE 1 also applies to other pixel groupings, provided that the intensity increase that occurs during the second interval is spread substantially equally among all spatially adjacent second interval pixels.

In practice, the first and second intervals discussed above follow each other in chronological order. However, such need not be the case. In general, the terms “first” and “second” intervals refer to two-time adjacent intervals, with no specific order of occurrence. In other words, the second interval pixels could actually appear first in time, followed by the first interval pixels.

The noise reduction technique described above can apply to non-pixel shift pulse width modulated displays. Rather than combine the fractional parts of first and second interval pixels within a single image frame and confining the noise intensity within one interval in the manner as described, the above-described method would achieve noise reduction by grouping at least one pixel in one frame with at least one pixel in the same position in another frame. The fractional parts of the grouped pixels in the two frames would undergo a combination followed by an intensity adjustment of the pixels between the two frames as similar to that described with respect to Table I. Thus, under such circumstances, the shift in light intensity would occur between different image frames, as opposed to different intervals in a single frame.

The foregoing provides technique for improved error diffusion for a pulse width modulated display.

1. A method for reducing noise in a display in which first interval pixels appear during a first interval and second interval pixels appear during a second interval, comprising the steps of:
filtering said first and second interval pixels, so each pixel has an intensity value comprised of an integer part and a fractional part,
grouping each first interval pixel with at least one second interval pixel such that said at least one grouped second interval pixel lies spatially adjacent to said first interval pixel;
combining the fractional parts of the first and second pixel intensity values; and
controlling the brightness of said grouped first and second interval pixels in accordance with their combined fractional parts.

2. The method according to claim 1 further comprising the steps of incrementing the integer part of the second interval pixel value when the combined fractional parts at least equals unity, and setting the fractional part of the second interval pixel to zero, while replacing the fractional part of the first interval pixel by the combination of fractional parts less unity.

3. The method according to claim 1 further comprising the step of maintaining the integer part of the second interval pixel value without change and replacing the fractional part with the combination of the fractional parts when the combination of fractional parts does not exceed unity.

4. The method according to claim 1 wherein the first and second interval pixels occur within a single frame.

5. A method for reducing noise in a display in which first interval pixels each appear in particular positions during a first image frame and second interval pixels each appear in corresponding positions during a second image frame, comprising the steps of:
filtering said first and second interval pixels, so each pixel has an intensity value comprised of an integer part and a fractional part,
grouping each first interval pixel with at least one second interval pixel such that said at least one grouped second interval pixel lies in the same position as the first interval pixel;
combining the fractional parts of the first and second pixel intensity values; and
controlling the brightness of said grouped first and second interval pixels in accordance with their combined fractional parts.

6. The method according to claim 5 further comprising the steps of incrementing the integer part of the second interval pixel value when their combined fractional parts at least equals unity, and setting the fractional part of the second interval pixel to zero, while replacing the fractional part of the first interval pixel by the combination of fractional parts less unity.

7. The method according to claim 6 further comprising the step of maintaining the integer part of the second interval pixel value and replacing the its fractional part with the combination of the fractional parts when the combination of fractional parts does not exceed unity.

8. Apparatus for reducing noise in a display in which first interval pixels appear during a first interval and second interval pixels appear during a second interval, comprising the steps of:
means for filtering incoming first and second interval pixels, so each pixel has an intensity value comprised of an integer part and a fractional part,
means for grouping each first interval pixel with at least one second interval pixel such that said at least one grouped second interval pixel lies spatially adjacent to said first interval pixel;
means for combining the fractional parts of the first and second pixel intensity values; and
means, for controlling the brightness of said grouped first and second interval pixels in accordance with their combined fractional parts

9. The apparatus according to claim 8 wherein the combining means: (a) increments the integer part of the second interval pixel value when the combination of the fractional parts of the first and second interval pixel values at least equals unity, (b) replaces the fractional part of the first interval pixel by the combination of fractional parts less unity, and (c) replaces the fractional part of the second interval pixel with zero.

10. The apparatus according to claim 9 wherein the combining means maintains the integer part of the second interval pixel value and replaces its fractional part with the combination of the fractional parts when the combination of fractional parts does not exceed unity.

11. The apparatus according to claim 9 wherein the first and second intervals pixels exist within a single frame.

12. Apparatus for reducing noise in a display in which first interval pixels each appear in particular positions during a first image frame and second interval pixels each appear in corresponding positions during a second image frame, comprising the steps of:
means for filtering said first and second interval pixels, so each pixel has an intensity value comprised of an integer part and a fractional part,
means for grouping each first interval pixel with at least one second interval pixel such that said at least one grouped second interval pixel lies in the same position as the first interval pixel;
means for combining the fractional parts of the first and second pixel intensity values; and
means for controlling the brightness of said grouped first and second interval pixels in accordance with their combined fractional parts.

13. The apparatus according to claim 12 wherein the combining means: (a) increments the integer part of the second interval pixel value when the combination of the fractional parts of the first and second interval pixel values at least equals unity, (b) replaces the fractional part of the first interval pixel by the combination of fractional parts less unity, and (c) replaces the fractional part of the second interval pixel with zero.

14. The apparatus according to claim 12 wherein the combining means maintains the integer part of the second interval pixel value and replaces its fractional part with the combination of the fractional parts when the combination of fractional parts does not exceed unity.
